(19) United States
(12) Patent Application Publication
(10) Pub. No.: US 2026/0124964 A1
(43) Pub. Date: May 7, 2026

(54) VEHICLE TAILGATE SEAT ASSEMBLY

(71) Applicant: Ford Global Technologies, LLC, Dearborn, MI (US)

(72) Inventors: Alejandro Garnica Izzo, Mexico City (MX); Sebastien Raymond Brunereau Callejas, Mexico City (MX); Bernardo Quintero Noriega, Ciudad López Mateos (MX); Carlos Buendia Moreno, Mexico City (MX); Diego Santamaria Cadena, Cuautitlán Izcalli (MX); Diego Ponton Medina, Mexico City (MX)

(73) Assignee: Ford Global Technologies, LLC, Dearborn, MI (US)

(21) Appl. No.: 18/935,738

(22) Filed: Nov. 4, 2024

(51) Int. Cl. B60N 2/005; B60N 2/30; B60N 3/10; B60R 9/06; B62D 33/023

(52) U.S. Cl. CPC B60N 2/005; B60N 2/3002; B60N 3/103; B60R 9/06; B62D 33/023

(57) ABSTRACT

A vehicle tailgate seat assembly has a base defining a first seat base, a second seat base and a central portion between the first seat base and the second seat base. A support structure is configured to connect the base onto a tailgate of a vehicle. A first seat back is pivotally connected to the base to provide a first seat back for the first seat when the seat back is in an open position. A second seat back is coupled to the base and configured to provide a second seat back for the second seat.

### FIELD OF THE DISCLOSURE

The present disclosure generally relates to vehicle seating assemblies, and more particularly relates to a tailgate style vehicle seat assembly configured to be assembled onto a tailgate of a vehicle.

### BACKGROUND OF THE DISCLOSURE

Motor vehicles are commonly equipped with interior seat assemblies to provide seating for passengers within the passenger compartment in the vehicle. Some vehicles may be equipped with tailgate style seating to allow tailgaters to be seated rearward facing at the rear end of the motor vehicle while the tailgate is open and the vehicle is parked and not operating. It would be desirable to provide for a tailgate seating arrangement for a vehicle that offers an easy to deploy and use seating assembly.

### SUMMARY OF THE DISCLOSURE

According to a first aspect of the present disclosure, a vehicle tailgate seat assembly has a base defining a first seat base, a second seat base and a central portion between the first seat base and the second seat base. A support structure is configured to connect the base onto a tailgate of a vehicle. A first seat back is pivotally connected to the base to provide a first seat back for the first seat when the seat back is in an open position. A second seat back is coupled to the base and configured to provide a second seat back for the second seat.

Embodiments of the first aspect of the present disclosure can include any one or a combination of the following features:
the first seat comprises a first seat cushion and the second seat comprises a second seat cushion;
the first seat back comprises a first seat back cushion and the second seat back comprises a second seat back cushion;
the first seat base and the first seat back form a first container when the first seat back is closed on top of the first seat base, and wherein the second seat back and the second seat base form a second container when the second seat back is closed on the second seat base;
the support structure comprises a plurality of clamping bars coupling the base onto the tailgate;
a storage box located vehicle forward of the base and connected to the plurality of clamping bars;
the storage box comprises a lid pivotally coupled to a storage box base;
a first latch mechanism on the first seat and a second latch mechanism on the second seat;
the central portion comprises a central module that may be removably connected to the base; and
the central module comprises one or more of a cup holder module, a storage box module and a fishing rod holder module.

According to a second aspect of the present disclosure, a vehicle tailgate for a pickup truck has a top support surface when the tailgate is in the open position and a vehicle tailgate seat assembly. The vehicle tailgate seat assembly has a base defining a first seat base, a second seat base and a central portion between the first seat base and the second seat base. A support structure is configured to connect the base onto a tailgate of a vehicle. A first seat back is pivotally connected to the base to provide a first seat back for the first seat when the seat back is in an open position. A second seat back is coupled to the base and configured to provide a second seat back for the second seat.

Embodiments of the second aspect of the present disclosure can include any one or a combination of the following features:
the first seat comprises a first seat cushion and the second seat comprises a second seat cushion;
the first seat back comprises a first seat back cushion and the second seat back comprises a second seat back cushion;
the first seat base and the first seat back form a first container when the first seat back is closed on top of the first seat base, and wherein the second seat back and the second seat base form a second container when the second seat back is closed on the second seat base;
the support structure comprises a plurality of clamping bars coupling the base onto the tailgate;
a storage box located vehicle forward of the base and connected to the plurality of clamping bars, wherein the storage box comprises a lid pivotally coupled to a storage box base;
a first latch mechanism on the first seat and a second latch mechanism on the second seat;
the central portion comprises a central module that may be removably connected to the base; and
the central module comprises one or more of a cup holder module, a storage box module and a fishing rod holder module.

According to a third aspect of the present disclosure, a motor vehicle has a body with a front end and a rear end, a tailgate located at the rear end of the body and moveable between an open position and a closed position and a vehicle tailgate seat assembly. The vehicle tailgate seat assembly has a base defining a first seat base, a second seat base and a central portion between the first seat base and the second seat base. A support structure is configured to connect the base onto a tailgate of a vehicle. A first seat back is pivotally connected to the base to provide a first seat back for the first seat when the seat back is in an open position. A second seat back is coupled to the base and configured to provide a second seat back for the second seat.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a rear upper perspective view of a motor vehicle configured as a pickup truck having a tailgate seat assembly arranged on a tailgate of the vehicle, according to one embodiment;

FIG. 2 is a rear upper perspective view of the rear end bed of the pickup truck with the tailgate in the open position and the vehicle tailgate seat assembly assembled on top thereof and in a stowed position;

FIG. 3 is a rear upper perspective view of the vehicle tailgate and seat assembly with first and second seats in deployed positions;

FIG. 4 is an upper perspective view of the vehicle tailgate and seat assembly with one of the seat assemblies in the deployed position;

FIG. 5 is a rear upper perspective view of the vehicle tailgate and seat assembly with a storage compartment in the open position;

FIG. 6 is a rear upper perspective view of the vehicle tailgate and seat assembly with user selectable center console assemblies;

FIG. 7 is a rear upper exploded perspective view of the vehicle tailgate and seat assembly shown in FIG. 3; and

FIG. 8 is an exploded front lower perspective view of the vehicle tailgate seat assembly shown in FIG. 7.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

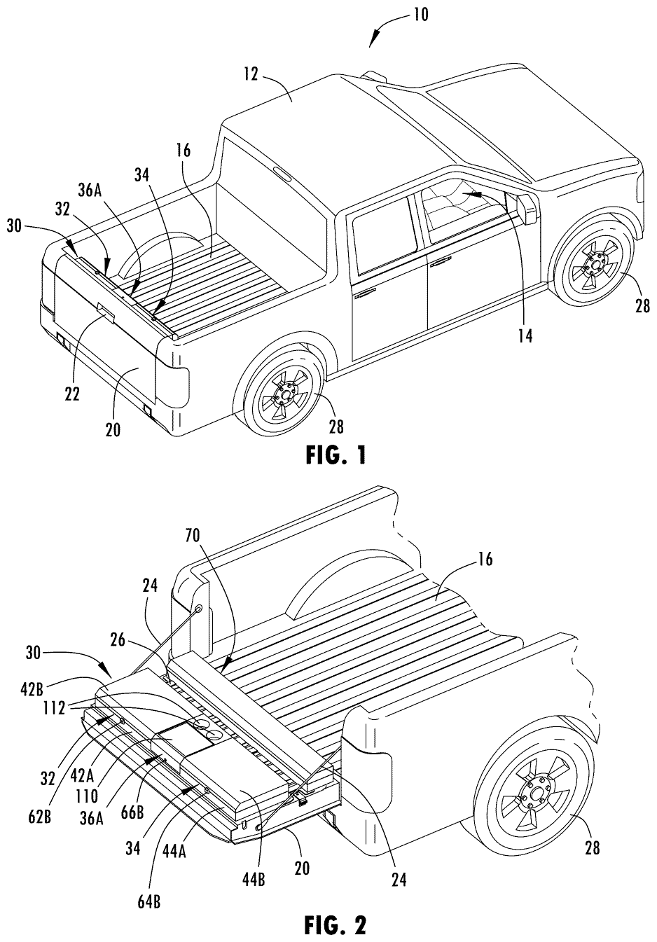

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle tailgate seat assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIGS. 1-8, a motor vehicle 10 in the form of a pickup truck is generally shown having a vehicle tailgate 20 equipped with a vehicle tailgate seat assembly 30, according to one embodiment. The vehicle tailgate seat assembly 30 has a base defining a first seat base, a second seat base and a central portion between the first seat base and the second seat base. The vehicle tailgate seat assembly 30 also includes a support structure configured to connect the base onto the tailgate of the motor vehicle 10. The vehicle tailgate seat assembly 30 further has a first seat back pivotally coupled to the base to provide a first seat back for the first seat when the seat back is in an open position, and a second seat back coupled to the base and configured to provide a second seat back for the second seat.

The motor vehicle 10 is shown in FIG. 1 as a wheeled automotive vehicle configured as a pickup truck that has a vehicle body generally configured with a passenger cab 12 generally in the middle portion and a bed 16 at the rear end. The passenger cab 12 defines a cabin interior 14 that typically includes a configuration of vehicle seating. The vehicle bed 16 at the rear end of the motor vehicle 10 has a floor, opposing left and right sidewalls, a front wall proximate the rear end of the cab 12 and a rear wall provided by a tailgate 20 when in the closed position. The motor vehicle 10 is equipped with a plurality of tire and wheel assemblies 28.

The motor vehicle 10 includes the tailgate 20 pivotally connected at the rear end of the bed 16. The tailgate 20 has a latch 22 that latches the tailgate 20 in the upstanding vertical closed position as seen in FIG. 1 and releases the tailgate 20 to allow the tailgate 20 to rotate downward and rearward to an open horizontal position as seen in FIG. 2. The tailgate 20 may be supported via a pair of cables 24 on opposite sides in the open position to maintain the horizontal position of the tailgate 20. It should be appreciated that the tailgate 20 in the open position provides an opening at the rear end of the motor vehicle 10 that enables increased access to the bed 16.

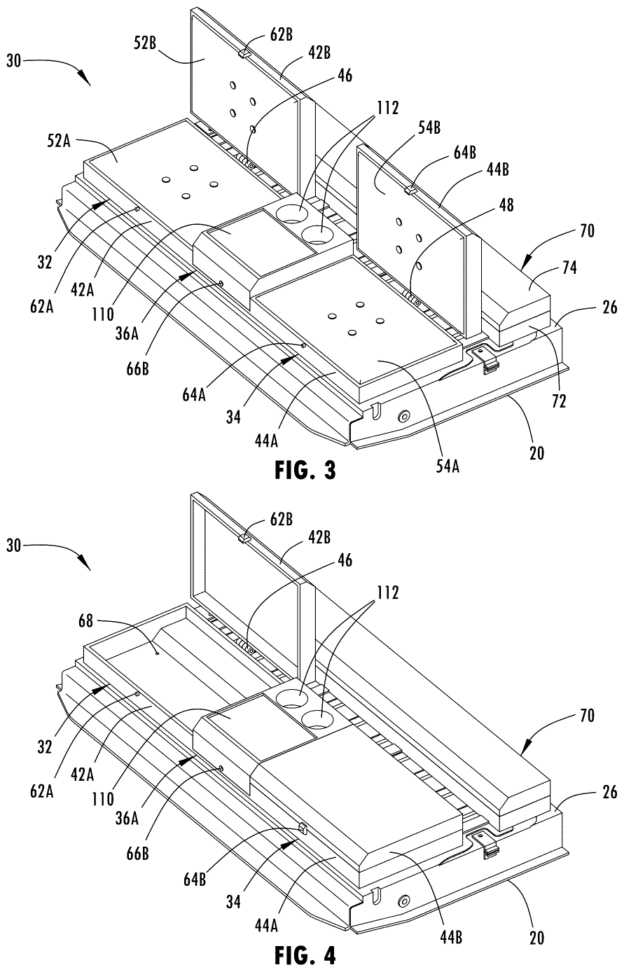

The tailgate 20 has a top side 26 when oriented in the open position with the vehicle tailgate seat assembly 30 shown assembled on the top side 26. The vehicle tailgate seat assembly 30 is shown in FIG. 2 in a fully stowed position and having a first tailgate seat 32, a second tailgate seat 34 and a modular console 36A disposed in the central portion 40 between the first and second seats 32 and 34. The first and second seats 32 and 34 are shown in FIG. 2 in the stowed configuration and are individually deployable from the stowed position to a use seating position as shown in FIG. 3. In the close position, the first and second seats 32 and 34 may form first and second containers to store cargo items. The vehicle tailgate seat assembly 30 also includes a storage compartment 38 shown vehicle forward in FIG. 2 and in a closed position.

The vehicle tailgate seat assembly 30 may be deployed when the motor vehicle 10 is parked and not operating with the tailgate 20 in the open position to provide for rear end tailgate seating at the rear end of the motor vehicle 10. Both of the first and second seats 32 and 34 may be deployed to a seating position facing vehicle rearward when the tailgate 20 is in the open position and the vehicle is stopped and inoperable, as shown in FIG. 3, or one of the seats 32 or 34 may be deployed alone as shown in FIG. 4. The first seat 32 includes a first seat base 42A connected to a first seat back 42B via one or more hinges 46 on the vehicle forward end. In the use position, the first seat back 42B is substantially vertical or may be slightly inclined forward or rearward and may be supported at the rear most inclined position by the storage compartment 70 located vehicle forward of the first seat 32. The first seat back 42B includes a latch 62B that may connect to a retaining feature 62A such as an opening or a striker in the seat base 42A.

The second seat 34 similarly includes a second seat base 44A pivotally connected to a second seat back 44B via one or more hinges 48 on the vehicle forward end. The second seat back 44B may be substantially vertical or slightly inclined forward or rearward in the seating position and may be supported by the storage compartment 70 located vehicle forward of the second seat 34 in the open position. The second seat 34 likewise has a latch 64B configured to matingly engage a latch retaining feature 64B such as an opening or a striker in the second seat base 44A in the closed position.

The modular center console 36A is a modular unit that may be disconnected and removed and replaced with a different selectable modular unit. In the embodiment shown in FIG. 3, the center console 36A generally has a cushioned arm rest 110 and a pair of drink holders 112 provided on top thereof. The modular center console 36A may be connected on the rear end to the seat base 50 via retainer features 67A matingly engaging retainer features 67B and may be connected on the front end with a releasable latch 66A.

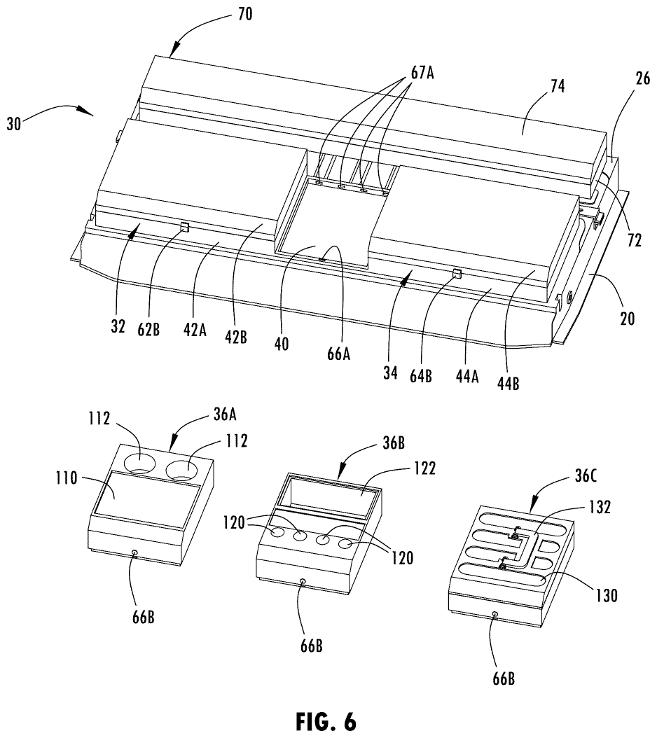

A user may unlatch the latch 66A and remove the modular center console 36A from the central portion 40 and the retainer features 67A and replace it with another modular console such as the modular consoles 36B or 36C shown in FIG. 6. In this example, the first center console 36A includes the arm rest 110 and the two drink holders 112. The second modular console 36B may include fishing rod holders 120 and a storage compartment 122. A third available center console 36C may include a storage box such as a tackle box having top trays 130 and a handle 132, for example. It should be appreciated that any of a number of different configurations of the selectable center console unit may be employed which are modular and may be interchanged and installed on the central portion 40.

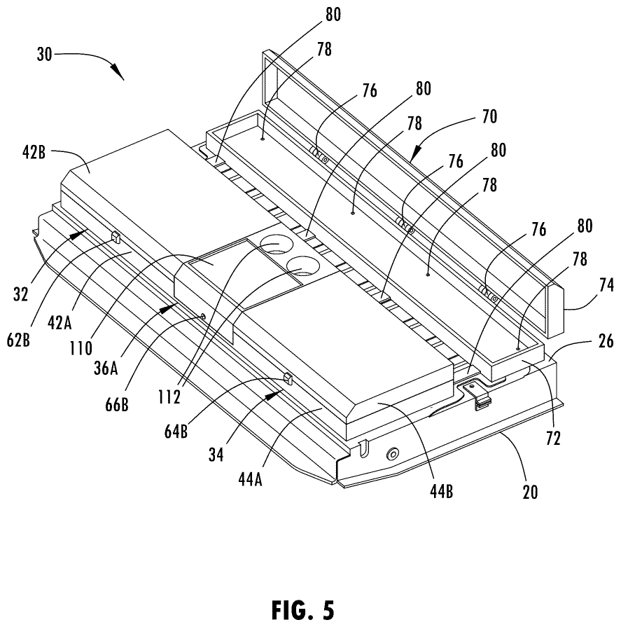

The vehicle tailgate seat assembly 30 further includes a storage box 70 such as a tool box assembled vehicle forward of the first and second seats 32 and 34 on the tailgate 20 when viewed in the open tailgate position. The storage box 70 includes a base housing 72 fastened onto the tailgate 20 and hingedly connected via hinges 76 to a lid 74. The storage box 70 may contain cargo items such as tools, for example, and be closed to contain and conceal the cargo items. The lid 74 may be latched closed and may be opened as illustrated in FIG. 5 to access the cargo items.

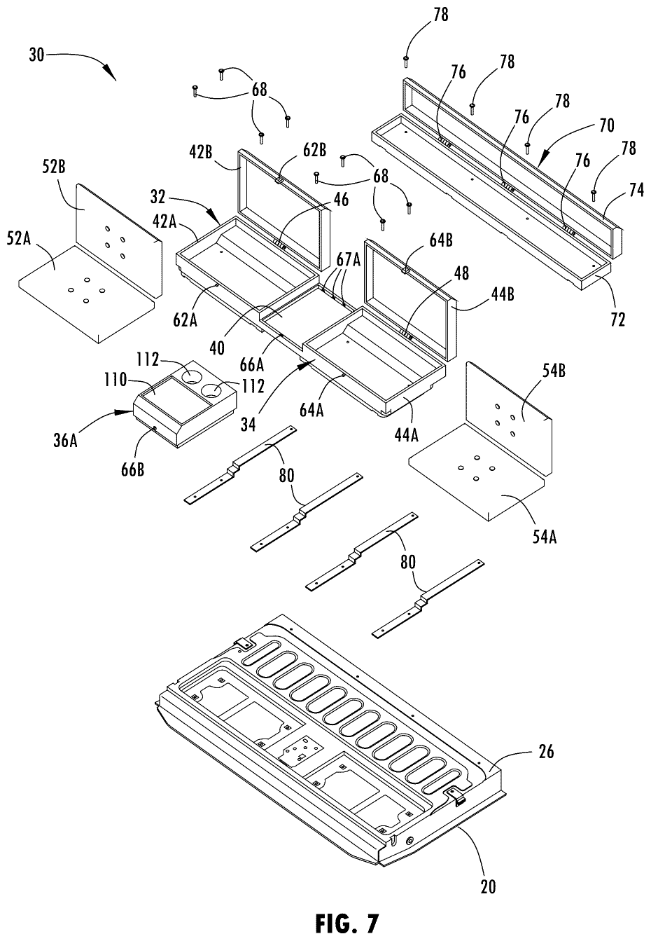

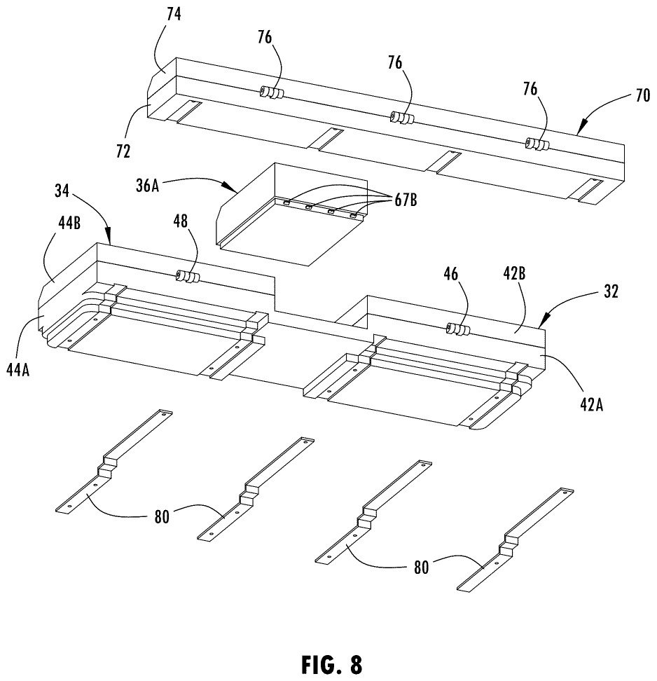

Referring to FIGS. 7 and 8, the assembly of the vehicle tailgate seat assembly 30 onto the vehicle tailgate 20 is further illustrated. The first and second seats 32 and 34 have a base which may include a common base 50 with the center console support central region 40 which may be assembled onto a plurality of support brackets 80 that serve as a support structure. In the example shown, four support brackets 80 are shown as elongated bars having steps to accommodate the different shaped connecting surfaces and further having fastener openings to receive and be fastened via fasteners 68 onto the top side 26 of the tailgate 20. The base 50 may otherwise be made up of separate components for each of the seat bases 42A and 44A and central portion 40, according to other embodiments. The common base 50 of the first and second seats 32 and 34 may be fastened via fasteners 68 onto the rearward most portion of the top side 26 of the tailgate 20 in the horizontal position. The storage box 70 may be fastened via fasteners 78 onto the vehicle forward portion of the tailgate 20.

The first seat 32 may include a first seat cushion 52A disposed in the first seat base 42A, and the first seat back 42B may include a first seat back cushion 52B disposed in the second seat back 52B. Similarly, the second seat 34 may include a second seat cushion 54A disposed in the second seat base 44A, and a second seat back cushion 54B disposed in the second seat back 44B.

The vehicle tailgate seat assembly 30 may be assembled onto the vehicle tailgate 20 by a vehicle original equipment manufacturer, according to one example. According to another example, the vehicle tailgate seat assembly 30 may be an aftermarket product that is added and installed by an installer on the tailgate 20 such as by a user or a service or installation provider.

The vehicle tailgate seat assembly 30 advantageously provides for tailgate seating on the tailgate 20 of a motor vehicle 10, such as a pickup truck. The tailgate seat assembly 30 may be stowed on the vehicle 10 with the tailgate 20 in either the open position or the closed position, and the seats 32 and 34 may be selectively deployed as needed with the tailgate 20 open in the horizontal position when the vehicle is stopped and inoperable. While the vehicle tailgate assembly 30 is shown and described herein is assembled onto a tailgate of a pickup truck, it should be appreciated that the vehicle tailgate seat assembly 30 may be assembled onto a tailgate on a sport utility vehicle (SUV) or other vehicle body configuration.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle tailgate seat assembly comprising:
a base defining a first seat base, a second seat base and a central portion between the first seat base and the second seat base;
a support structure configured to connect the base onto a tailgate of a vehicle;
a first seat first back pivotally connected to the base to provide a first seat back for the first seat when the seat back is in an open position; and
a second seat back coupled to the base and configured to provide a second seat back for the second seat.

2. The vehicle tailgate seat assembly of claim 1, wherein the first seat comprises a first seat cushion and the second seat comprises a second seat cushion.

3. The vehicle tailgate seat assembly of claim 2, wherein the first seat back comprises a first seat back cushion and the second seat back comprises a second seat back cushion.

4. The vehicle tailgate seat assembly of claim 1, wherein the first seat base and the first seat back form a first container when the first seat back is closed on top of the first seat base, and wherein the second seat back and the second seat base form a second container when the second seat back is closed on the second seat base.

5. The vehicle tailgate seat assembly of claim 4, wherein the support structure comprises a plurality of clamping bars coupling the base onto the tailgate.

6. The vehicle tailgate seat assembly of claim 5, further comprising a storage box located vehicle forward of the base and connected to the plurality of clamping bars.

7. The vehicle tailgate seat assembly of claim 6, wherein the storage box comprises a lid pivotally coupled to a storage box base.

8. The vehicle tailgate seat assembly of claim 1, further comprising a first latch mechanism on the first seat and a second latch mechanism on the second seat.

9. The vehicle tailgate seat assembly of claim 1, wherein the central portion comprises a central module that may be removably connected to the base.

10. The vehicle tailgate seat assembly of claim 9, wherein the central module comprises one or more of a cup holder module, a storage box module and a fishing rod holder module.

11. A vehicle tailgate for a pickup truck, the vehicle tailgate comprising:
a top support surface when the tailgate is in the open position; and
a vehicle tailgate seat assembly comprising:
a base defining a first seat base, a second seat base and a central portion between the first seat base and the second seat base;
a support structure configured to connect the base onto a tailgate of a vehicle;
a first seat back pivotally connected to the base to provide a first seat back for the first seat when the seat back is in an open position; and
a second seat back coupled to the base and configured to provide a second seat back for the second seat.

12. The vehicle tailgate for a pickup truck of claim 11, wherein the first seat comprises a first seat cushion and the second seat comprises a second seat cushion.

13. The vehicle tailgate for a pickup truck of claim 12, wherein the first seat back comprises a first seat back cushion and the second seat back comprises a second seat back cushion.

14. The vehicle tailgate for a pickup truck of claim 11, wherein the first seat base and the first seat back form a first container when the first seat back is closed on top of the first seat base, and wherein the second seat back and the second seat base form a second container when the second seat back is closed on the second seat base.

15. The vehicle tailgate for a pickup truck of claim 14, wherein the support structure comprises a plurality of clamping bars coupling the base onto the tailgate.

16. The vehicle tailgate for a pickup truck of claim 15, further comprising a storage box located vehicle forward of the base and connected to the plurality of clamping bars, wherein the storage box comprises a lid pivotally coupled to a storage box base.

17. The vehicle tailgate for a pickup truck of claim 11, further comprising a first latch mechanism on the first seat and a second latch mechanism on the second seat.

18. The vehicle tailgate for a pickup truck of claim 11, wherein the central portion comprises a central module that may be removably connected to the base.

19. The vehicle tailgate for a pickup truck of claim 18, wherein the central module comprises one or more of a cup holder module, a storage box module and a fishing rod holder module.

20. A motor vehicle comprising:
a body having a front end and a rear end;
a tailgate located at the rear end of the body and moveable between an open position and a closed position; and
a vehicle tailgate seat assembly comprising:
a base defining a first seat base, a second seat base and a central portion between the first seat base and the second seat base;
a support structure configured to connect the base onto a tailgate of a vehicle;
a first seat back pivotally connected to the base to provide a first seat back for the first seat when the seat back is in an open position; and
a second seat back coupled to the base and configured to provide a second seat back for the second seat.
